(19) United States
(12) Patent Application Publication
(10) Pub. No.: US 2009/0226772 A1
(43) Pub. Date: Sep. 10, 2009

(54) Apparatus, System, and Method For Supplying Fuel To And Removing Waste From Fuel Cells

(75) Inventors: Joseph Stark, Orlando, FL (US); Paul Knauer, San Jose, CA (US); Sanjiv Malhotra, Castro Valley, CA (US)

Correspondence Address: COOLEY GODWARD KRONISH LLP;ATTN: Patent Group, Suite 1100, 777 - 6th Street, NW, WASHINGTON, DC, 20001, US

(73) Assignee: OORJA PROTONICS, INC., Fremont, CA (US)

(21) Appl. No.: 12/201,806

(22) Filed: Aug. 29, 2008

Related U.S. Application Data
(60) Provisional application No. 60/967,104, filed on Aug. 30, 2007.

(51) Int. Cl. H01M 8/04; B67D 5/04; B67D 5/58

(52) U.S. Cl. 429/13; 429/22; 141/285; 141/85

(57) ABSTRACT

Described herein are fuel cell system refueling devices and related systems and methods. In one embodiment, a refueling device includes a fuel handling unit that includes a fuel port and a fuel conveyance unit to convey fuel to a fuel cell system. The refueling device also includes a waste handling unit that includes a waste port and a waste conveyance unit to convey waste from the fuel cell system. The refueling device further includes a communication port and a refueling device controller to establish a communication link with the fuel cell system, such that the fuel cell system directs operation of the fuel handling unit and the waste handling unit.

### CROSS REFERENCE TO RELATED APPLICATION

This application claims the benefit of U.S. Provisional Application Ser. No. 60/967,104, filed on Aug. 30, 2007, the disclosure of which is incorporated herein by reference in its entirety.

### FIELD OF THE INVENTION

The present invention relates to fuel cells, and, more particularly, to supplying fuel to and removing waste from fuel cells.

### BACKGROUND

A fuel cell, like an ordinary battery, provides direct current electricity from two electrochemical reactions. These reactions occur at electrodes to which reactants are fed. For example, in an alcohol combustion fuel cell, a negative electrode (i.e., anode) is maintained by supplying an alcohol-based fuel such as methanol, whereas a positive electrode (i.e., cathode) is maintained by supplying oxygen or air. When providing a current, fuel is electrochemically oxidized at an anode electro-catalyst to produce electrons, which travel through an external circuit to a cathode electro-catalyst where they are consumed together with oxygen in a reduction reaction. A circuit is maintained within the fuel cell by the conduction of protons in an electrolyte.

A fuel cell stack typically includes a series of individual fuel cells. Each fuel cell includes an anode and cathode pair. A voltage across each fuel cell is determined by the type of electrochemical reaction occurring in the cell. For example, the voltage can vary from 0 V to 0.9 V for a typical alcohol combustion single cell, depending upon the current generated. The current generated in the cell depends on the operating condition and design of the cell, such as electro-catalyst composition/distribution, active surface area of a membrane electrode assembly, characteristics of a gas diffusion layer, flow field design of an anode and cathode plates, cell temperature, reactant concentration, reactant flow and pressure distribution, reaction by-product or waste removal, and so forth. The reaction area of a cell, number of cells in series, and the type of electrochemical reaction in the fuel cell stack determine a current and hence a power supplied by the fuel cell stack. For example, the typical power of an alcohol combustion fuel cell stack can range from a few watts to several kilowatts. A fuel cell system typically integrates a fuel cell stack along with different subsystems for the management of water, fuel, waste, air, humidification, and heat. These subsystems are sometimes collectively referred to as the balance of plant.

Fuel cell systems are increasingly being used to power devices, such as forklifts, pallet loaders, automated-guided vehicles, and other material handling equipment. In order to successfully integrate fuel cell systems into an even wider range of devices, it is desirable to efficiently service the fuel cell systems. In particular, refueling and waste removal should be accomplished quickly, so as to reduce the downtime of a device that is powered by a fuel cell system. Also, refueling and waste removal should be accomplished in a manner that meets environmental and safety regulations and does not require extensive operator supervision.

It is against this background that a need arose to develop the refueling devices and related systems and methods described herein.

### SUMMARY

One aspect of the invention relates to a refueling device for servicing a fuel cell system. In one embodiment, the refueling device includes a fuel handling unit that includes a fuel port and a fuel conveyance unit connected to the fuel port. The fuel conveyance unit is configured to convey fuel from the refueling device to the fuel cell system via the fuel port. The refueling device also includes a waste handling unit that includes a waste port and a waste conveyance unit connected to the waste port. The waste conveyance unit is configured to convey waste from the fuel cell system to the refueling device via the waste port. The refueling device further includes a communication port and a refueling device controller connected to the fuel handling unit, the waste handling unit, and the communication port. The refueling device controller is configured to establish a communication link with the fuel cell system via the communication port, such that the fuel cell system directs operation of the fuel handling unit and the waste handling unit.

In another embodiment, the refueling device includes a common port configured to pass fuel and waste. The refueling device also includes a fuel conveyance unit and a waste conveyance unit that are each connected to the common port. The fuel conveyance unit is configured to convey the fuel along a fuel flow pathway passing through the common port, and the waste conveyance unit is configured to convey the waste along a waste flow pathway passing through the common port. The refueling device further includes a flow pathway selector that is connected between the common port and each of the fuel conveyance unit and the waste conveyance unit, and the flow pathway selector is configured to select between the fuel flow pathway and the waste flow pathway.

Another aspect of the invention relates to a fuel cell system. In one embodiment, the fuel cell system includes a fuel input port, a fuel storage unit connected to the fuel input port, a communication port, a first sensor connected to the fuel input port and the communication port, and a second sensor connected to the fuel storage unit. The first sensor is configured to produce a first output indicative of a connection between a refueling device and at least one of the fuel input port and the communication port, and the second sensor is configured to produce a second output indicative of a fuel level of the fuel storage unit. The fuel cell system also includes a fuel cell system controller connected to the first sensor, the second sensor, and the communication port. The fuel cell system controller is configured to direct operation of the refueling device via the communication port, and the fuel cell system controller is configured to direct conveyance of fuel from the refueling device to the fuel storage unit based on the first output and the second output.

A further aspect of the invention relates to a method for servicing a fuel cell system using a refueling device. In one embodiment, the method includes detecting a connection between the refueling device and the fuel cell system. The method also includes, responsive to detecting the connection, determining a fuel level of a fuel storage unit included in the fuel cell system. The method also includes, responsive to determining that the fuel level is below a threshold fuel level, initiating conveyance of fuel from the refueling device to the fuel storage unit. The method further includes, responsive to determining that the fuel level is at least the threshold fuel level, terminating conveyance of fuel from, the refueling device to the fuel storage unit.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates an overall system implemented in accordance with an embodiment of the invention.

FIG. 2 illustrates a refueling device to service a fuel cell system, according to another embodiment of the invention.

FIG. 3 illustrates a state diagram for refueling and waste removal operations, according to an embodiment of the invention.

FIG. 4 illustrates a refueling device implemented in accordance with another embodiment of the invention.

FIG. 5 illustrates a refueling device implemented in accordance with another embodiment of the invention.

FIG. 6 illustrates a refueling device implemented in accordance with another embodiment of the invention.

FIG. 7 illustrates a refueling device implemented in accordance with a further embodiment of the invention.

### DETAILED DESCRIPTION

### Definitions

The following definitions apply to some of the components described with respect to some embodiments of the invention. These definitions may likewise be expanded upon herein.

As used herein, the singular terms “a,” “an,” and “the” include plural referents unless the context clearly dictates otherwise. Thus, for example, reference to a sensor can include multiple sensors unless the context clearly dictates otherwise.

As used herein, the term, “set” refers to a collection of one or more components. Thus, for example, a set of sensors can include a single sensor or multiple sensors. Components of a set can be referred to as members of the set. Components of a set can be the same or different. In some instances, components of a set can share one or more common characteristics.

As used herein, the terms “optional” and “optionally” mean that the described event or circumstance may or may not occur, and that the description includes instances where the event or circumstance occurs and instances in which it does not.

As used herein, the terms “connect,” “connected,” and “connection” refer to an operational coupling or linking. Connected components can be directly coupled to one another or can be indirectly coupled to one another, such as via another set of components.

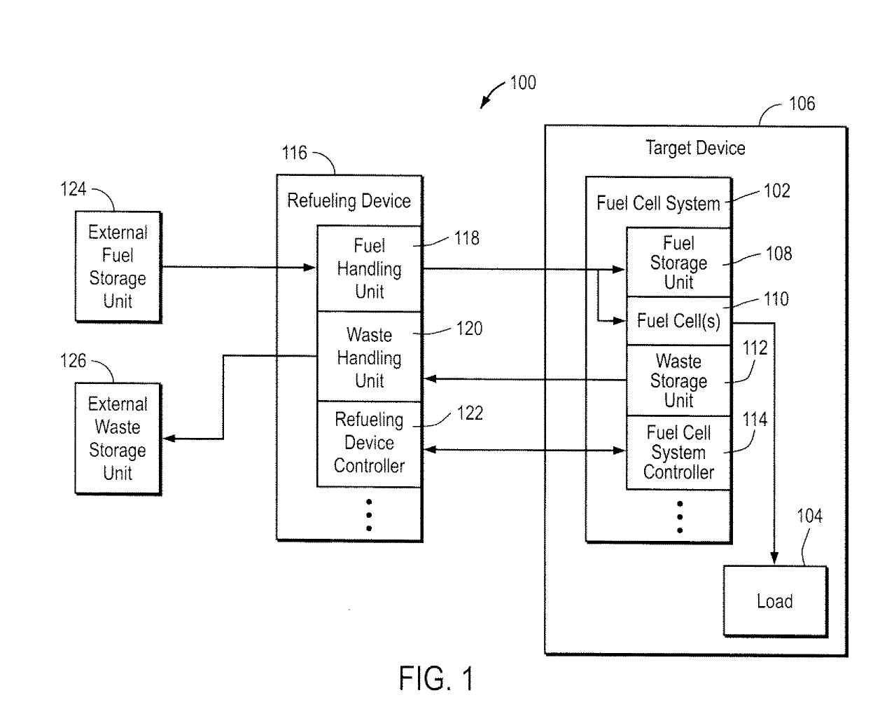

Attention first turns to FIG. 1, which illustrates an overall system 100 implemented in accordance with an embodiment of the invention. A fuel cell system 102 is implemented as an integral component or as a separate component of a target device 106, which can be a mobile device such as a vehicle or a device that operates at a fixed location. As illustrated in FIG. 1, the fuel cell system 102 includes a fuel storage unit 108, a set of fuel cells 110, a waste storage unit 112, and a fuel cell, system controller 114. The fuel cells 110 can be implemented as an alcohol combustion fuel cell stack that consumes an alcohol-based fuel, such as ethanol or methanol, and supplies electrical power to a load 104, such as a thermal or an electrical load. Depending on the particular implementation, little or no waste can be accumulated during operation of the fuel cell system 102, in which case the waste storage unit 112 can be optionally omitted.

As illustrated in FIG. 1, the fuel cell system 102 is serviced by a refueling device 116. In particular, the refueling device 116 supplies fuel to the fuel cell system 102, such that neither the fuel cells 110 nor the fuel storage unit 108 needs to be removed from the target device 106. In addition, any accumulated waste is removed from the fuel cell system 102 by the same refueling device 116. In the illustrated embodiment, the refueling device 116 includes a fuel handling unit 118, a waste handling unit 120, and a refueling device controller 122. During refueling operations, the fuel handling unit 118 conveys fuel from an external fuel storage unit 124 to the fuel storage unit 108 of the fuel cell system 102. Depending on the particular implementation, the refueling device 116 can store fuel onboard, in which case the external fuel storage unit 124 can be optionally omitted. Also, the fuel handling unit 118 can convey fuel directly to the fuel cells 110, such as for an implementation in which the fuel cells 110 supply electrical power to the refueling device 116. During waste removal operations, the waste handling unit 120 conveys waste from the waste storage unit 112 of the fuel cell system 102 to the refueling device 116, and either stores this waste onboard or conveys it to an external waste storage unit 126. For implementations in which little or no waste is accumulated by the fuel cell system 102, the waste handling unit 120 can be optionally omitted.

Advantageously, the illustrated embodiment includes control and safety mechanisms to provide safe and regulated operations during refueling and waste removal. In particular, the fuel cell system controller 114 and the refueling device controller 122 operate in conjunction to control the refueling and waste removal operations in a substantially automated manner and in compliance with environmental and safety regulations. The refueling and waste removal operations can occur sequentially or in parallel, the latter of which allows enhanced servicing throughput and reduces the downtime of the target device 106. In addition, the illustrated embodiment allows multiple fuel cell systems, each having its own distinct refueling and waste removal requirements, to be serviced by the same refueling device 116, with little or no modification and operator supervision when servicing the fuel cell systems. As further described herein, this can be accomplished by establishing a communication link between the fuel cell system controller 114 and the refueling device controller 122, thereby allowing the fuel cell system controller 114 to control the refueling device 116 in accordance with particular refueling and waste removal requirements of the fuel cell system 102.

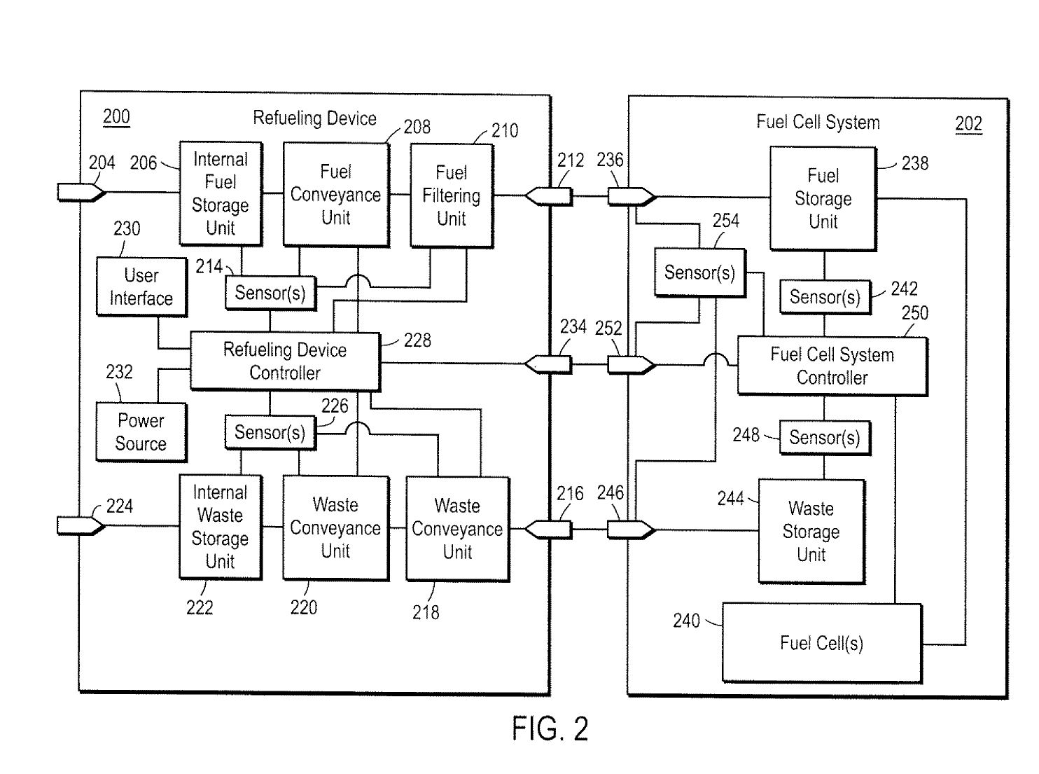

Attention next turns to FIG. 2, which illustrates a refueling device 200 to service a fuel cell system 202 according to another embodiment of the invention.

In the illustrated embodiment, the refueling device 200 includes a fuel input port 204, an internal fuel storage unit 206, a fuel conveyance unit 208, a fuel filtering unit 210, a fuel output port 212, and a set of sensors 214, which collectively correspond to a fuel handling unit to supply fuel to the fuel cell system 202. Various components of the fuel handling unit are connected to one another to define a fuel flow pathway extending between the fuel input port 204 and the fuel output port 212. It should be recognized that the particular implementation of these components is provided by way of example, and these components can be combined, sub-divided, or re-ordered in accordance with another implementation. Also, certain of these components can be optionally omitted for another implementation.

Referring to FIG. 2, the particular implementation of the fuel input port 204 can vary depending upon whether the refueling device 200 operates at a fixed location or is a mobile device. In the case of the refueling device 200 operating at a fixed location, fuel can be conveyed, via the fuel input port 204, from an external fuel storage unit (not illustrated), and the fuel input port 204 can be implemented to provide a fixed fluid connection with a manual shut-off mechanism. This fixed implementation allows multiple refueling devices to share a common external fuel storage unit, and to service multiple fuel cell systems for enhanced servicing throughput. In the case of a mobile implementation, the refueling device 200 stores fuel onboard in the internal fuel storage unit 206, and subsequently conveys the fuel to the fuel cell system 202 in situ. In this case, the fuel input port 204 can be implemented to provide a temporary fluid connection, with a mechanism to facilitate engaging and disengaging with an external fuel storage unit (not illustrated). Similarly, the fuel output port 212 can include a mechanism to facilitate engaging and disengaging with the fuel cell system 202. In addition, the particular implementation of the fuel output port 212 can depend upon environmental and safety regulations at a location in which the fuel cell system 202 operates. For example, the fuel output port 232 can be implemented to provide a positive-locking, dry-break fluid connection. For enhanced safety, a flow of fuel should not exceed a blocking pressure rating of the fuel output port 212.

The internal fuel storage unit 206 can be implemented as a relatively rigid fuel storage tank or as a relatively non-rigid or expandable fuel storage tank. In the case of the refueling device 200 operating at a fixed location, the internal fuel storage unit 206 can be optionally omitted. In the case of a mobile implementation, the internal fuel storage unit 206 provides onboard storage of fuel, and the fuel conveyance unit 208 conveys the fuel to the fuel cell system 202 in situ. The fuel conveyance unit 208 can be implemented as a pump along with other optional flow control or flow restrictive components to meet safety regulations and a desired level of servicing throughput. In the illustrated embodiment, the fuel conveyance unit 208 conveys fuel along a substantially unidirectional flow pathway passing through the fuel output port 212. However, it is also contemplated that the fuel conveyance unit 208 can convey fuel along a bi-directional flow pathway. In such manner, the refueling device 200 can. remove substantially all fuel from the fuel cell system 202 to facilitate its shipment to another location.

As illustrated in FIG. 2, the fuel filtering unit 210 is disposed along the fuel flow pathway, and operates to reduce Or minimize the level of contaminants in fuel supplied to the fuel cell system 202. In such manner, the fuel filtering unit 210 allows the use of a lower purity or lower grade fuel, thereby providing cost savings. The fuel filtering unit 210 can be implemented as a set of filters to process fuel in-line as it is conveyed to the fuel cell system 202 or as part of separate filtering operations, such as along a re-circulating fuel filtration pathway. Examples of filters that can be used include particulate and ionic filters. Particulate filters are typically passive components including screens or meshes, but can also operate with a centrifugal or another active mechanism. Ionic filters typically involve a chemical or electrochemical mechanism to achieve separation of contaminants. An in-line implementation of the fuel filtering unit 210 can simplify related hardware and control mechanisms. In the case of a re-circulating implementation, the fuel filtering unit 210 can be powered and operated during time intervals prior to servicing the fuel cell system 202.

The sensors 214 are connected to the internal fuel storage unit 206, the fuel conveyance unit 208, and the fuel filtering unit 210, and operate to monitor an operational status of these connected components. The particular implementation of the sensors 214 can vary depending upon the particular implementation of these connected components and the desired complexity for related control mechanisms. For example, the sensors 214 can monitor fault events related to the internal fuel storage unit 206. In particular, a leak sensor can produce an output indicative of a critical fault event that terminates refueling operations, while a level sensor can produce an output indicative of an empty or low fuel level. In the case of an expandable implementation of the internal fuel storage unit 206, a pressure sensor can be used in place of a level sensor to monitor fuel levels. For implementations in which fuel is actively pumped or re-circulated, an electrical current or voltage sensor can monitor pumping or re-circulating operations and indicate a fault event, such, as a pump failure, a line blockage, or a vacuum condition. The sensors 214 can also monitor fuel flow rates and pressures, such as using in-line flow meters and pressure gauges.

In the illustrated embodiment, the refueling device 200 also includes a waste input port 216, a waste conveyance unit 218, a waste filtering unit 220, an internal waste storage unit 222, a waste output port 224, and a set of sensors 226, which collectively correspond to a waste handling unit to remove waste from the fuel cell system 202. Various components of the waste handling unit are connected to one another to define a waste flow pathway extending between the waste input port 216 and the waste output port 224. It should be recognized that the particular implementation of these components is provided by way of example, and these components can be combined, sub-divided, or re-ordered in accordance with another implementation. Also, certain components can be optionally omitted for another implementation. In the illustrated embodiment, the waste flow pathway is separate from the fuel flow pathway to reduce or minimize mixing of waste and fuel. However, it is also possible that the waste flow pathway and the fuel flow pathway can share a common pathway for handling fuel and waste.

Referring to FIG. 2, the waste input port 216 and the waste output port 224 can be implemented in a similar manner as the fuel output port 212 and the fuel input port 204, respectively. For example, in the case of the refueling device 200 operating at a fixed location, the waste output port 224 can be implemented to provide a fixed fluid connection, and, in the case of a mobile implementation, the waste output port 224 can be implemented to provide a temporary fluid connection, with a mechanism to facilitate engaging and disengaging with an external waste storage unit (not illustrated). The waste input port 216 can include a mechanism to facilitate engaging and disengaging with the fuel cell system 202, along with a mechanism to provide a positive-locking, dry-break fluid connection. In the illustrated embodiment, the waste input port 216 is separate from the fuel output port 212, and serves as a dedicated port for handling waste. However, it is also contemplated that a common port can be used for handling fuel and waste.

The internal waste storage unit 222 and the waste conveyance unit 218 can be implemented in a similar manner as the internal fuel storage unit 206 and the fuel conveyance unit 208, respectively. For example, the internal waste storage unit 222 can be implemented as a relatively rigid waste storage tank or as an expandable waste storage tank. In the case of the refueling device 200 operating at a fixed location, the internal waste storage unit 222 can be optionally omitted. In the case of a mobile implementation, the refueling device 200 stores waste onboard in the internal waste storage unit 222, and subsequently conveys the waste to an external waste storage unit (not illustrated). Similar to the fuel conveyance unit 208, the waste conveyance unit 218 can be implemented as a pump along with other optional flow control or flow restrictive components. In the illustrated embodiment, the waste conveyance unit 218 conveys waste from the fuel cell system 202 along a substantially unidirectional flow pathway passing through the waste input port 216. However, it is also contemplated that the waste conveyance unit 218 can convey waste along a bi-directional flow pathway. In such manner, the waste output port 224 can be optionally omitted, and the refueling device 200 can remove waste from the fuel cell system 202, via the port 216, and can subsequently convey the waste, via the same port 216, to an external waste storage unit (not illustrated).

As illustrated in FIG. 2, the waste filtering unit 220 is disposed along the waste flow pathway, and operates to reduce or minimize the level of contaminants in waste removed from the fuel cell system 202. In the case of alcohol combustion, a typical waste is water along with contaminants, such as trace amounts of an alcohol-based fuel, metal ions, and dissolved carbon dioxide. This waste can be filtered to allow its disposal in accordance with environmental regulations or to allow its recycling for use in the fuel filtering unit 210. Similar to the fuel filtering unit 210, the waste filtering unit 220 can be implemented as a set of filters to process waste in-line or as part of separate filtering operations, such as along a re-circulating waste filtration pathway. In the case of a re-circulating implementation, the waste filtering unit 220 can be powered and operated during time intervals prior to servicing the fuel cell system 202.

The sensors 226 are connected to the internal waste storage unit 222, the waste filtering unit 220, and the waste conveyance unit 218, and operate to monitor an operational status of these connected components. The sensors 226 can be implemented in a similar manner as the sensors 214, and can include a particular combination of leak sensors, level sensors, pressure sensors, electrical current or voltage sensors, flow meters, or pressure gauges.

Still referring to FIG. 2, the refueling device 200 also includes a refueling device controller 228, which is connected to and directs operation of various components of the refueling device 200. In the illustrated embodiment, the refueling device controller 228 is implemented as a slave controller that directs refueling and waste removal operations subject to control by the fuel cell system 202. In conjunction, the refueling device controller 228 tracks the operational status of the refueling device 200 in accordance with outputs of the sensors 214 and 226, and conveys the operational status to the fuel cell system 202. This is accomplished via a communication port 234, which can be implemented to provide a wired connection, such a cable connection, or a wireless connection, such as an optical or radio-frequency connection. A wired connection can allow for both data communication and electrical power to be conveyed between the fuel cell system 202 and the refueling device 200, while a wireless connection can simplify operator intervention when servicing the fuel cell system 202. In the vicinity of several refueling devices, as can be found in certain industrial applications, a wired connection can be implemented so as to uniquely identify the particular refueling device 200 connected to the fuel cell system 202.

The refueling device 200 further includes a user interface 230 and a power source 232, which can be implemented as a battery. The user interface 230 provides indications of operational status to an operator, including alerts regarding any fault events, and the power source 232 supplies electrical power to the refueling device controller 228 and other active components of the refueling device 200. In general, the refueling device 200 can derive electrical power from any of three sources: (1) the power source 232; (2) an external power source (not illustrated), such as an alternating current power source; and (3) the fuel cell, system 202. In the case of the refueling device 200 operating at a fixed location, electrical power can be supplied by either the fuel cell system 202 or by an external power source, in which case the onboard power source 232 can be optionally omitted. For a mobile implementation of the refueling device 200, electrical power can be supplied by either the fuel cell system 202 or by the onboard power source 232.

The fuel cell system 202 includes a fuel input port 236 and a fuel storage unit 238, which are connected to one another to define a fuel flow pathway that supplies fuel to a set of fuel cells 240. The fuel input port 236 can be implemented in a similar manner as the fuel output port 232, and can include a mechanism to facilitate engaging and disengaging with the refueling device 200. The fuel storage unit 238 can be implemented as a relatively rigid fuel storage tank or as an expandable fuel storage tank, A set of sensors 242 are connected to the fuel storage unit 238, and operate to monitor an operational status of the fuel storage unit 238. The particular implementation of the sensors 242 can vary depending upon the particular implementation of the fuel storage unit 238 and the desired complexity for related control mechanisms. For example, the sensors 242 can include a level sensor or a pressure sensor to produce outputs indicative of fuel levels. Other implementations of the sensors 242 can include a particular combination of leak sensors, flow meters, or pressure gauges.

Referring to FIG. 2, the fuel cell system 202 also includes a waste storage unit 244 and a waste output port 246, which are connected to one another to define a waste flow pathway that removes waste from the fuel cells 240. The waste output port 246 can be implemented in a similar manner as the waste input port 216, and can include a mechanism to facilitate engaging and disengaging with the refueling device 200. In the illustrated embodiment, the waste output port 246 is separate from the fuel input port 236, and serves as a dedicated port for handling waste. However, it is also contemplated that a common port can be used for handling fuel and waste. The waste storage unit 244 can be implemented as a relatively rigid waste storage tank or as an expandable waste storage tank. A set of sensors 248 are connected to the waste storage unit 244, and operate to monitor an operational status of the waste storage unit 244. The particular implementation of the sensors 248 can vary depending upon the particular implementation of the waste storage unit 244 and the desired complexity for related control mechanisms. For example, the sensors 248 can include a level sensor or a pressure sensor to produce outputs indicative of waste levels. Other implementations of the sensors 248 can include a particular combination of leak sensors, flow meters, or pressure gauges.

The fuel cell system 202 further includes a fuel cell system controller 250, which is connected to and directs operation of various components of the fuel cell system 202. In particular, the fuel cell system controller 250 tracks the operational status of the fuel cell system 202 in accordance with outputs of the sensors 242 and 248. In the illustrated embodiment, the fuel cell system controller 250 is implemented as a master controller that directs refueling and waste removal operations by controlling the refueling device controller 228. In conjunction, the fuel cell system controller 250 tracks the operational status of the refueling device 200 as conveyed by the refueling device controller 228. This is accomplished via a communication port 252, which can be implemented to provide a wired connection or a wireless connection. It is contemplated that the master-slave assignments can be switched for another implementation, with the refueling device controller 228 serving as a master controller, and the fuel cell system controller 250 serving as a slave controller.

A set of sensors 254 are connected to the fuel input port 236, the communication port 252, and the waste output port 246, and operate to monitor a connection status of the ports 236, 252, and 246. The sensors 254 can include a proximity or contact sensor to produce an output indicative of a fluid connection between the ports 212 and 236 or between the ports 216 and 246, and a proximity or contact sensor to produce an output indicative of a wired or wireless connection between the ports 234 and 252. The fuel cell system controller 250 tracks the connection status of the ports 236, 252, and 246 in accordance with outputs of the sensors 254, so as to automatically detect an operator's intention to service the fuel cell system 202.

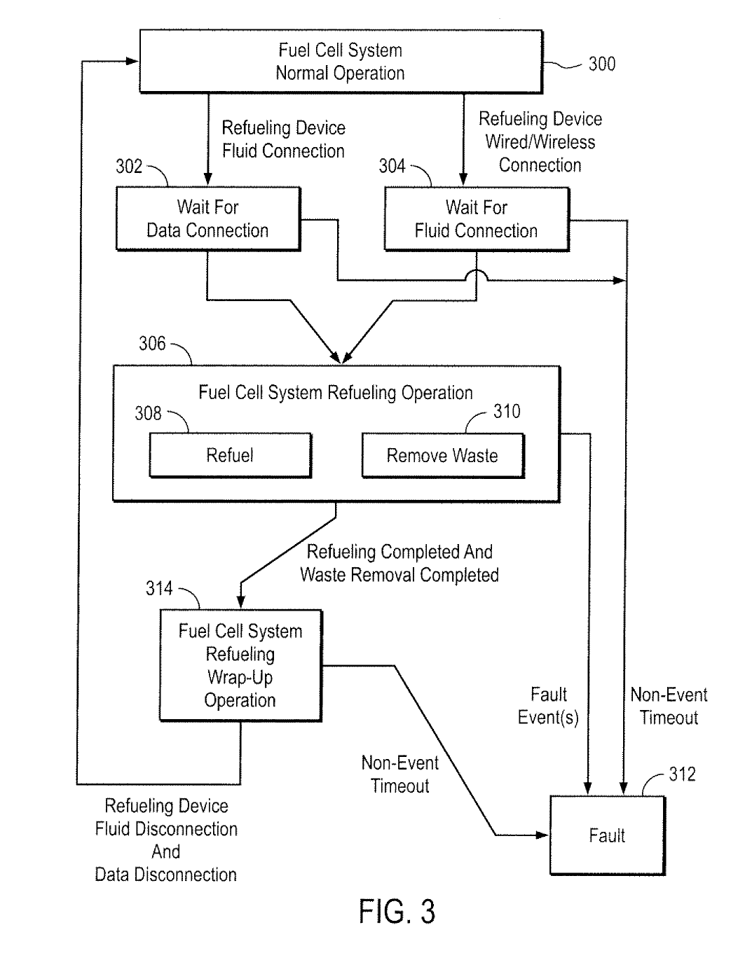

The operation of the fuel cell system controller 250 can be further understood with reference to FIG. 3, which illustrates a state diagram for refueling and waste removal operations, according to an embodiment of the invention.

Referring to FIG. 3, the fuel cell system controller 250 initially directs operation of the fuel cell system 202 in a normal operation state (block 300). If the fuel cell system controller 250 first detects a fluid connection to either of, or both, the fuel input port 236 and the waste output port 246, the fuel cell system controller 250 exits the normal operation state and waits for a wired or wireless connection to the communication port 252 (block 302). If the wired or wireless connection is detected within a particular time interval, such as a pre-determined or operator-selectable time interval, the fuel cell system controller 250 establishes a communication link with the refueling device controller 228. Otherwise, the fuel cell system controller 250 transitions to a fault state (block 312). Similarly, if the fuel cell system controller 250 first detects a wired or wireless connection to the communication port 252, the fuel cell system controller 250 exits the normal operation state and waits for a fluid connection to either of, or both, the fuel input port 236 and the waste output port 246 (block 304). If the fluid connection is detected within a particular time interval, such as a pre-determined or operator-selectable time interval, the fuel cell system controller 250 establishes a communication link with the refueling device controller 228. Otherwise, the fuel cell system controller 250 transitions to the fault state (block 312). A communication link can be established using a set of request and acknowledgement messages that are exchanged between the fuel cell system controller 250 and the refueling device controller 228. Once the communication link is established, the fuel cell system controller 250 transitions to a refueling operation state (block 306).

In the refueling operation state, the fuel cell system controller 250 tracks the operational status of the fuel cell system 202 as well as the operational status of the refueling device 200. In particular, the fuel cell system controller 250 determines fuel and waste levels of the fuel cell system 202. If the fuel level of the fuel cell system 202 is below a threshold fuel level, such as a pre-determined or operator-selectable fuel level, the fuel cell system controller 250 assumes control of the refueling device 200, via the refueling device controller 228, and initiates refueling operations (block 308). If the waste level of the fuel cell system 202 is at or above a threshold waste level, such as a pre-determined or operator-selectable waste level, the fuel cell system controller 250 initiates waste removal operations (block 310). The refueling and waste removal operations can occur sequentially or in parallel.

If a fault event is detected while in the refueling operation state, the fuel cell system controller 250 transitions to the fault state, and alerts an operator via the user interface 230 (block 312). Examples of fault events include an overcurrent condition of the fuel conveyance unit 208, an overcurrent condition of the waste conveyance unit 218, a leak of the internal fuel storage unit 206 of the refueling device 200, an empty or low fuel level of the internal fuel storage unit 206, a leak of the internal waste storage unit 222 of the refueling device 200, a full waste level of the internal waste storage unit 222, the refueling operations taking longer than a particular time interval, and the waste removal operations taking longer than a particular time interval. In the case of a critical fault event, such as a leak, the fuel cell system controller 250 can substantially immediately terminate the refueling and waste removal operations. In the event of a non-critical fault event, the fuel cell system controller 250 can direct the refueling and waste removal operations to be continued in a safe manner, albeit at a reduced performance level. The fuel cell system controller 250 can reference mass flow characteristics of fuel and waste, characteristics of the fuel and waste handling units, and other information contained in an associated memory to control and monitor the flow of fuel and waste. If the flow characteristics are not within expected ranges, the fuel cell system controller 250 can detect a fault event, and can alert the operator via the user interface 230.

In the absence of a fault event, the fuel cell system controller 250 terminates the refueling operations once the fuel level of the fuel cell system 202 is at or above the threshold fuel level. Also, once the waste level of the fuel cell system 202 is below the threshold waste level, the fuel cell system controller 250 terminates the waste removal operations. The fuel cell system controller 250 then transitions to a refueling wrap-up operation state (block 314).

In the refueling wrap-up operation state, the fuel cell system controller 250 alerts the operator regarding completion of refueling and waste removal, via the user interface 230. Also, the fuel cell system controller 250 waits for the operator to disconnect the refueling device 200 with respect to the fuel input port 236, the communication port 252, and the waste output port 246. If disconnection does not take place within a particular time interval, such as a pre-determined or operator-selectable time interval, the fuel cell system controller 250 transitions to the fault state (block 312). Otherwise, the fuel cell system controller 250 terminates the communication link with the refueling device controller 228, and transitions back to the normal operation state (block 300).

The foregoing provides a general overview of some embodiments of the

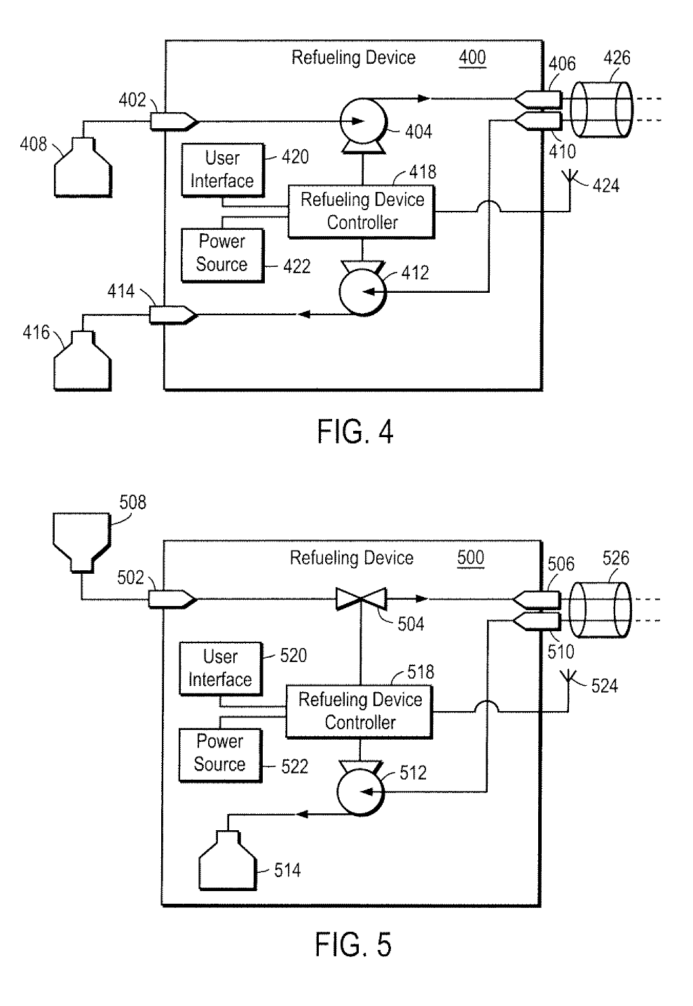

invention. Attention next turns to FIG. 4 through FIG. 7, which illustrate specific

implementations in. accordance with other embodiments of the invention.

FIG. 4 illustrates a refueling device 400 implemented in accordance with an embodiment of the invention. In particular, the refueling device 400 is implemented so as to have reduced complexity by omitting internal fuel and waste storage tanks, sensors, and other related components.

Referring to FIG. 4, the refueling device 400 includes a fuel input port 402, a fuel pump 404, and a fuel output port 406, which are connected to one another to define a fuel flow pathway and collectively correspond to a fuel handling unit. During refueling operations, the fuel pump 404 conveys fuel from an external fuel storage tank 408 to a fuel cell system (not illustrated). The refueling device 400 also includes a waste input port 410, a waste pump 412, and a waste output port 414, which are connected to one another to define a waste flow pathway and collectively correspond to a waste handling unit. The fuel output port 406 and the waste input port 410 are implemented within a common hose or tube 426, which facilitates simultaneous engagement and disengagement with the fuel cell system. During waste removal operations, the waste pump 412 conveys waste from the fuel cell system to an external waste storage tank 416. Additional reduction in complexity is accomplished by omitting sensors to monitor an operational state of the fuel pump 404 and the waste pump 412. Still referring to FIG. 4, the refueling device 400 further includes a refueling device controller 418, which is connected to and directs operation of a user interface 420 and other components of the refueling device 400. Data communication is established via a communication port 424, which is implemented to provide a wireless connection between the refueling device controller 418 and the fuel cell system. In the illustrated embodiment, electrical power is supplied by an onboard power source 422.

FIG. 5 illustrates a refueling device 500 implemented in accordance with another embodiment of the invention. In particular, the refueling device 500 is implemented so as to have reduced complexity by omitting a fuel pump, sensors, and other related components. Omission of the fuel pump can reduce the possibility of electrical sparks, and can be desirable for certain hazardous environments.

Referring to FIG. 5, the refueling device 500 includes a fuel input port 502, a flow control component 504, and a fuel output port 506, which are connected to one another to define a fuel flow pathway and collectively correspond to a fuel handling unit. In the illustrated embodiment, the fuel handling unit operates by gravity, and, during refueling operations, fuel is gravity-fed from an external fuel storage tank 508 and conveyed to a fuel cell system (not illustrated). The flow control component 504 can be implemented as a two-way solenoid valve or another type of controllable valve to gate the flow of fuel to the fuel cell system. The refueling device 500 also includes a waste input port 510, a waste pump 512, and an internal waste storage tank 514, which are connected to one another to define a waste flow pathway and collectively correspond to a waste handling unit. The fuel output port 506 and the waste input port 510 are implemented within a common hose or tube 526, which facilitates simultaneous engagement and disengagement with the fuel cell system. During waste removal operations, the waste pump 512 conveys waste from the fuel cell system to the internal waste storage tank 514. When the internal waste storage tank 514 becomes full, the tank 514 is removed, emptied, and then returned to the refueling device 500. The internal waste storage tank 514 can be formed from a translucent or transparent material and placed at a visible location within the refueling device 500, thereby obviating the use of sensors to monitor waste levels. Additional reduction in complexity is accomplished by omitting sensors to monitor an operational state of the waste pump 512. Still referring to FIG. 5, the refueling device 500 further includes a refueling device controller 518, which is connected to and directs operation of a user interface 520 and other components of the refueling device 500. Data communication is established via a communication port 524, which is implemented to provide a wireless connection, and electrical power is supplied by an onboard power source 522.

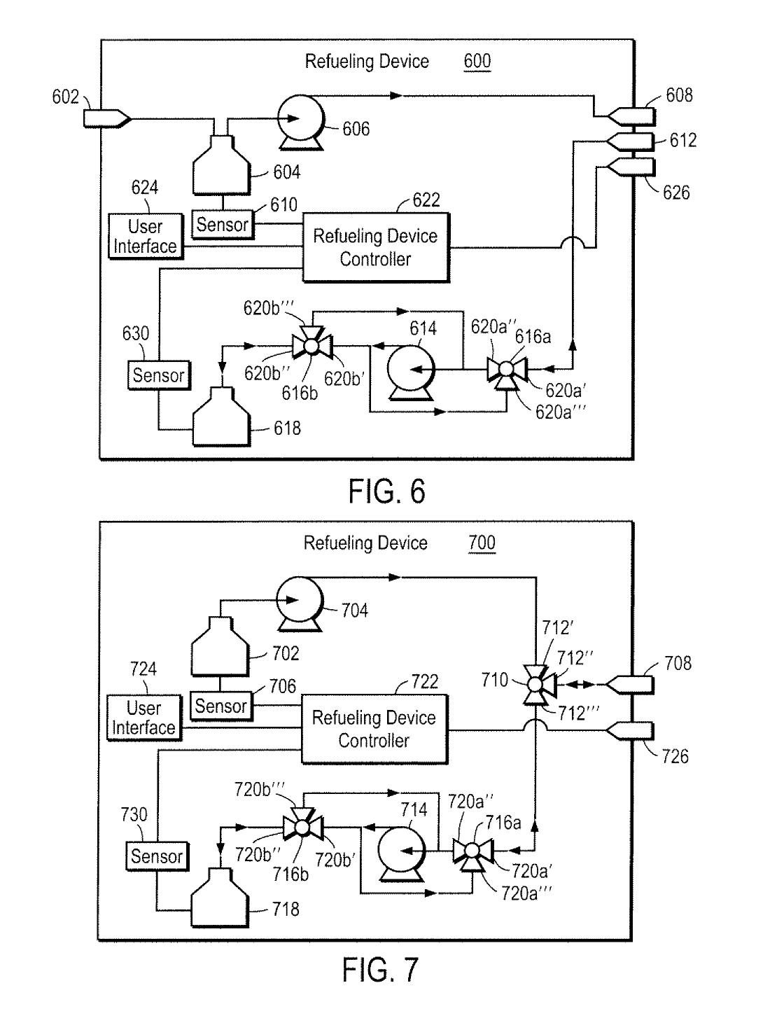

FIG. 6 illustrates a refueling device 600 implemented in accordance with another embodiment of the invention. In particular, the refueling device 600 is implemented so as to provide a bi-directional flow of waste.

Referring to FIG. 6, the refueling device 600 includes a fuel input port 602, an internal fuel storage tank 604, a fuel pump 606, a fuel output port 608, and a sensor 610, which are connected to one another and collectively correspond to a fuel handling unit. During refueling operations, the fuel pump 606 conveys fuel from the internal fuel storage tank 604 to a fuel cell system (not illustrated) via the fuel output port 608. The sensor 610 monitors fuel levels, and can be implemented as a level sensor or a pressure sensor. When the internal fuel storage tank 604 becomes empty, the fuel pump 606 replenishes the tank 604 with fuel from an external fuel storage tank (not illustrated) via the fuel input port 602. The refueling device 600 also includes a waste input port 612, a waste pump 614, a pair of three-way solenoid valves 616a and 616b, an internal waste storage tank 618, and a sensor 630, which are connected to one another and collectively correspond to a waste handling unit. The solenoid valves 616a and 616b are controlled to provide a bi-directional flow of waste. During waste removal operations, the waste pump 614 conveys waste from the fuel cell system to the internal waste storage tank 618, via ports 620a′ and 620a″ of the solenoid valve 616a and via ports 620b′ and 620b″ of the solenoid valve 616b. The sensor 630 monitors waste levels, and can be implemented as a level sensor or a pressure sensor. When the internal waste storage tank 618 becomes full, the waste pump 614 conveys waste from the internal waste storage tank 618 to an external waste storage tank (not illustrated), via ports 620b″ and 620b′″ of the solenoid valve 616b and via ports 620a′″ and 620a′ of the solenoid valve 616a. Still referring to FIG. 6, the refueling device 600 further includes a refueling device controller 622, which is connected to and directs operation of a user interface 624 and other components of the refueling device 600. In the illustrated embodiment, port 626 is implemented as a common port for data communication and for supplying electrical power from the fuel cell system to various components of the refueling device 600.

FIG. 7 illustrates a refueling device 700 implemented in accordance with a further embodiment of the invention. In particular, the refueling device 700 is implemented so as to have reduced plumbing by including a common port 708 for passing fluid and waste and a flow pathway selector, which is implemented as a three-way solenoid valve 710. The solenoid valve 710 is controlled to select between a fuel flow pathway and a waste flow pathway passing through the common port 708.

Referring to FIG. 7, the refueling device 700 includes an internal fuel storage tank 702, a fuel pump 704, and a sensor 706, which are connected to one another and collectively correspond to a fuel handling unit. During refueling operations, the fuel pump 704 conveys fuel from the internal fuel storage tank 702 to a fuel cell system (not illustrated), along a fuel flow pathway passing through ports 712′ and 712″ of the solenoid valve 710 and through the common port 708. The sensor 706 monitors fuel levels and can be implemented as a level sensor or a pressure sensor. When the internal fuel storage tank 702 becomes empty, the tank 702 is removed, replenished with fuel, and then returned to the refueling device 700. The refueling device 700 also includes a waste pump 714, a pair of three-way solenoid valves 716a and 716b, an internal waste storage tank 718, and a sensor 730, which are connected to one another and collectively correspond to a waste handling unit. The solenoid valves 716a and 716b are controlled to provide a bi-directional flow of waste. During waste removal operations, the waste pump 714 conveys waste from the fuel cell system to the internal waste storage tank 718, along a waste flow pathway passing through the common port 708, through ports 712″ and 712″′ of the solenoid valve 710, through ports 720a′ and 720a″ of the solenoid valve 716a, and through ports 720b′ and 720b″ of the solenoid valve 716b. The sensor 730 monitors waste levels, and can be implemented as a level sensor or a pressure sensor. When the internal waste storage tank 718 becomes full, the waste pump 714 conveys waste from the internal waste storage tank 718 to an external waste storage tank (not illustrated), along a waste flow pathway passing through ports 720b″ and 720b′″ of the solenoid valve 736b, through ports 720a′″ and 720a′ of the solenoid valve 716a, through ports 712″′ and 712″ of the solenoid valve 710, and through the common port 708.

Still referring to FIG. 7, the refueling device 700 further includes a refueling device controller 722, which is connected to and directs operation of a user interface 724 and other components of the refueling device 700. In the illustrated embodiment, port 726 is implemented as a common port for data communication and for supplying electrical power from the fuel cell system to various components of the refueling device 700.

Some embodiments of the invention relate to a computer-readable storage medium having computer code stored thereon for performing various computer-implemented operations. The media and computer code may be those specially designed and constructed for the purposes of the invention, or they may be of the kind well known and available to those having skill in the computer software arts. Examples of computer-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; and hardware devices that are specially configured to store and execute program code, such as Application-Specific Integrated Circuits (“ASICs”), Programmable Logic Devices (“PLDs”), and ROM and RAM devices. Examples of computer code include, but are not limited to, machine code, such as produced by a compiler, and files containing higher-level code that are executed by a computer using an interpreter. For example, an embodiment of the invention may be implemented using Java, C++, or other object-oriented programming language and development tools. Additional examples of computer code include, but are not limited to, encrypted code and compressed code.

Some embodiments of the invention can be implemented using computer code in place of, or in combination with, hardwired circuitry. For example, with reference to FIG. 1, the refueling device controller 122 and the fuel cell system controller 114 can be implemented using computer code, hardwired circuitry, or a combination thereof.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A refueling device for servicing a fuel cell system, comprising:
a fuel handling unit including
a fuel port, and
a fuel conveyance unit connected to the fuel port, the fuel conveyance unit configured to convey fuel from the refueling device to the fuel cell system via the fuel port;
a waste handling unit including
a waste port, and
a waste conveyance unit connected to the waste port, the waste conveyance unit configured to convey waste from the fuel cell system to the refueling device via the waste port;
a communication port; and
a refueling device controller connected to the fuel handling unit, the waste handling unit, and the communication port, the refueling device controller configured to establish a communication link with the fuel cell system via the communication port, such that the fuel cell system directs operation of the fuel handling unit and the waste handling unit.

2. The refueling device of claim 1, wherein the fuel port is a fuel output port, the fuel handling unit further includes a fuel input port connected to the fuel conveyance unit, and the fuel conveyance unit is configured to convey the fuel along a fuel flow pathway extending between the fuel input port and the fuel output port.

3. The refueling device of claim 2, wherein the fuel handling unit further includes an internal fuel storage unit connected between the fuel input port and the fuel output port and disposed along the fuel flow pathway.

4. The refueling device of claim 2, wherein the fuel handling unit further includes a fuel filtering unit connected between the fuel input port and the fuel output port and disposed along the fuel flow pathway.

5. The refueling device of claim 1, wherein the fuel handling unit further includes an internal fuel storage unit connected to the fuel conveyance unit, and the fuel conveyance unit is configured to convey the fuel along a fuel flow pathway extending between the internal fuel storage unit and the fuel port.

6. The refueling device of claim 5, wherein the fuel handling unit further includes a fuel filtering unit connected between the internal fuel storage unit and the fuel port and disposed along the fuel flow pathway.

7. The refueling device of claim 1, wherein the fuel handling unit further includes a sensor configured to monitor an operational status of the fuel handling unit, and the refueling device controller is configured to convey the operational status to the fuel cell system via the communication port, such that the fuel cell system directs operation of the fuel handling unit based on the operational status.

8. The refueling device of claim 1, wherein the waste port is a waste input port, the waste handling unit further includes a waste output port connected to the waste conveyance unit, and the waste conveyance unit is configured to convey the waste along a waste flow pathway extending between the waste input port and the waste output port.

9. The refueling device of claim 8, wherein the waste handling unit further includes a waste filtering unit connected between the waste input port and the waste output port and disposed along the waste flow pathway.

10. The refueling device of claim 1, wherein the waste handling unit further includes an internal waste storage unit connected to the waste conveyance unit, and the waste conveyance unit is configured to convey the waste along a waste flow pathway extending between the waste port and the internal waste storage unit.

11. The refueling device of claim 10, wherein at least a portion of the waste flow pathway is bi-directional, and the waste port is configured as a common port for waste input and waste output.

12. The refueling device of claim 10, wherein the waste handling unit further includes a waste filtering unit connected between the waste port and the internal waste storage unit and disposed along the waste flow pathway.

13. The refueling device of claim 1, wherein the waste handling unit further includes a sensor configured to monitor an operational status of the waste handling unit, and the refueling device controller is configured to convey the operational status to the fuel cell system via the communication port, such that the fuel cell system directs operation of the waste handling unit based on the operational status.

14. A refueling device for servicing a fuel cell system, comprising:
a common port configured to pass fuel and waste;
a fuel conveyance unit connected to the common port, the fuel conveyance unit configured to convey the fuel along a fuel flow pathway passing through the common port;
a waste conveyance unit connected to the common port, the waste conveyance unit configured to convey the waste along a waste flow pathway passing through the common port; and
a flow pathway selector connected between the common port and each of the fuel conveyance unit and the waste conveyance unit, the flow pathway selector configured to select between the fuel flow pathway and the waste flow pathway.

15. The refueling device of claim 14, further comprising an internal fuel storage unit connected to the fuel conveyance unit, and the fuel conveyance unit is configured to convey the fuel along the fuel flow pathway extending between the internal fuel storage unit and the common port.

16. The refueling device of claim 14, further comprising an internal waste storage unit connected to the waste conveyance unit, and the waste conveyance unit is configured to convey the waste along the waste flow pathway extending between the common port and the internal waste storage unit.

17. The refueling device of claim 16, wherein at least a portion of the waste flow pathway is bi-directional.

18. The refueling device of claim 14, further comprising:
a communication port; and
a refueling device controller connected to the fuel conveyance unit, the waste conveyance unit, the flow pathway selector, and the communication port, the refueling device controller configured to establish a communication link with the fuel cell system via the communication port, such that the fuel cell system directs operation of the fuel conveyance unit, the waste conveyance unit, and the flow pathway selector.

19. A fuel cell system, comprising:
a fuel input port;
a fuel storage unit connected to the fuel input port;
a communication port;
a first sensor connected to the fuel input port and the communication port, the first sensor configured to produce a first output indicative of a connection between a refueling device and at least one of the fuel input port and the communication port;
a second sensor connected to the fuel storage unit, the second sensor configured to produce a second output indicative of a fuel level of the fuel storage unit; and
a fuel cell system controller connected to the first sensor, the second sensor, and the communication port, the fuel cell system controller configured to direct operation of the refueling device via the communication port, the fuel cell system controller configured to direct conveyance of fuel from the refueling device to the fuel storage unit based on the first output and the second output.

20. The fuel cell system of claim 19, wherein the fuel cell system controller is configured to initiate conveyance of fuel from the refueling device to the fuel storage unit if the first output is indicative of the connection between the refueling device and each of the fuel input port, and the communication port.

21. The fuel cell system of claim 19, wherein the fuel cell system controller is configured to initiate conveyance of fuel from the refueling device to the fuel storage unit if the second output is indicative of the fuel level being below a threshold fuel level.

22. The fuel cell system of claim 21, wherein the fuel cell system controller is configured to terminate conveyance of fuel from the refueling device to the fuel storage unit if the second output is indicative of the fuel level being at least the threshold fuel level.

23. The fuel cell system of claim 19, further comprising:
a waste output port;
a waste storage unit connected to the waste output port; and
a third sensor connected to the waste storage unit, the third sensor configured to produce a third output indicative of a waste level of the waste storage unit,
wherein the first sensor is connected to the waste output port, and the first sensor is configured to produce the first output indicative of the connection between the refueling device and at least one of the fuel input port, the communication port, and the waste output port, and
wherein the fuel cell system controller is connected to the third sensor, and the fuel cell system controller is configured to direct conveyance of waste from the waste storage unit to the refueling device based on the first output and the third output.

24. The fuel cell system of claim 23, wherein the fuel cell system controller is configured to initiate conveyance of waste from the waste storage unit to the refueling device if the first output is indicative of the connection between the refueling device and each of the communication port and the waste output port.

25. The fuel cell system of claim 23, wherein the fuel cell system controller is configured to initiate conveyance of waste from the waste storage unit to the refueling device if the third output is indicative of the waste level being at least a threshold waste level.

26. The fuel cell system of claim 25, wherein the fuel cell system controller is configured to terminate conveyance of waste from the waste storage unit to the refueling device if the third output is indicative of the waste level being below the threshold waste level.

27. A method for servicing a fuel cell system using a refueling device, comprising:
detecting a connection between the refueling device and the fuel cell system;
responsive to detecting the connection, determining a fuel level of a fuel storage unit included in the fuel cell system;
responsive to determining that the fuel level is below a threshold fuel level, initiating conveyance of fuel from the refueling device to the fuel storage unit; and
responsive to determining that the fuel level is at least the threshold fuel, level, terminating conveyance of fuel from the refueling device to the fuel storage unit.

28. The method of claim 27, further comprising:
monitoring an operational status of the refueling device to detect a fault event; and
responsive to detecting the fault event, terminating conveyance of fuel from the refueling device to the fuel storage unit.

29. The method of claim 27, further comprising:
responsive to detecting the connection, determining a waste level of a waste storage unit included in the fuel ceil system;
responsive to determining that the waste level is at least a threshold waste level, initiating conveyance of waste from the waste storage unit to the refueling device; and
responsive to determining that the waste level is below the threshold waste level, terminating conveyance of waste from the waste storage unit to the refueling device.

30. The method of claim 29, further comprising:
monitoring an operational status of the refueling device to detect a fault event; and
responsive to detecting the fault event, terminating conveyance of waste from the waste storage unit to the refueling device.
